(19) United States
(12) Patent Application Publication
(10) Pub. No.: US 2021/0245350 A1
(43) Pub. Date: Aug. 12, 2021

(54) VIBRATION REDUCING STRUCTURE OF PNEUMATIC HAMMER

(71) Applicant: STORM PNEUMATIC TOOL CO., LTD., Taichung City (TW)

(72) Inventor: Yung Yung SUN, Taichung City (TW)

(21) Appl. No.: 16/901,788

(22) Filed: Jun. 15, 2020

Related U.S. Application Data
(63) Continuation-in-part of application No. 16/784,770, filed on Feb. 7, 2020.

(51) Int. Cl. B25D 17/24; B25D 9/04

(52) U.S. Cl. CPC B25D 17/245; B25D 9/04; B25D 2250/181; B25D 2250/375; B25D 2250/365; B25D 2217/0073

(57) ABSTRACT

A vibration reducing structure of pneumatic hammer includes a handle having a concave room with a bottom wall and an air inlet channel communicating with the concave room. A control valve is disposed in the air inlet channel. A movable inner tube shell is accommodated in an outer tube shell coupled with the concave room and extends a rear bucket portion into the concave room. A movable hammer member, an air inlet valve for activating the hammer member and a hole communicating the air inlet channel to the air inlet valve are disposed in the inner tube shell. An air room is formed between the bottom wall and an end wall of the inner tube shell. A communicating channel communicates the air inlet channel to the air room for air with high pressure entering the air room.

This Application is being filed as a Continuation-in-Part of U.S. patent application Ser. No. 16/784,770, filed 7 Feb. 2020, currently pending.

### BACKGROUND OF THE INVENTION

### 1. Technical Field

The present invention relates to a pneumatic hammer and more particularly to a vibration reducing structure of pneumatic hammer.

### 2. Description of Related Art

As shown in FIG. 4, a conventional gun-shaped pneumatic hammer includes a handle portion 81 with an air inlet channel 83 and a tube portion 82 with an air inlet valve 84 and a movable hammer member 85. The hammer member 85 is driven by high pressure air to move back and forth in the tube portion 82 for hammering work.

Vibration is generated due to the movement of the hammer member 85, which has a bad effect upon user's hand that grasps the pneumatic hammer during use. In light of this, a space 86 with an elastic rubber chunk 87 and a spring 88 is disposed behind of the tube portion 82. The rubber chunk 87 and the spring 88 abut against the tube portion 82. When the hammer member 85 moves backward and causes the tube portion 82 to vibrate, the rubber chunk 87 and the spring 88 are compressed so that the vibration can be reduced.

The hammer member 85, however, acts up to several thousand times per minute, that is, the rubber chunk 87 has to bear the deformations several thousand times in one minute. Owing to the nature limitation of rubber material, the deformed rubber chunk 87 fails to restore original size so quickly before suffering next compression so as to lower the effect upon vibration reducing. In addition, such a high-frequency movement of the hammer member 85 will fatigue the rubber chunk 87 to lose its elasticity, not capable of taking effect upon vibration reducing anymore.

Another conventional straight pneumatic hammer shown in FIG. 5 is different in shape from the pneumatic hammer abovementioned for convenient operation in specific situations. Owing to the shape of this pneumatic hammer, an air inlet channel 93 is located just behind a handle portion 91 and a tube portion 92 so that there is no space to assemble rubber chunk or spring for vibration reduction.

### BRIEF SUMMARY OF THE INVENTION

The primary objective of the present invention is to provide a pneumatic hammer having an air room that is filled up with high pressure air for reducing vibration in the course of the hammer action, never losing the effort of vibration reducing due to elastic fatigue.

To achieve the above objective, the present invention provides a vibration reducing structure of pneumatic hammer including a handle having a concave room with an opening end and a bottom wall. The handle has an air inlet channel communicating with the concave room. The air inlet channel is provided with a control valve for controlling air to pass through. An outer tube shell is coupled with the opening end of the concave room while a movable inner tube shell is accommodated in the outer tube shell with a front tube portion and a rear bucket portion extending into the concave room. A movable hammer member, an air inlet valve for activating the hammer member and a hole communicating the air inlet channel to the air inlet valve are disposed in the inner tube shell. An air room is formed between the bottom wall and an end wall of the rear bucket portion. A sealing ring is provided at the rear end to closely connect with the concave room to seal the air room. A communicating channel communicates the air inlet channel to the air room for air with high pressure entering the air room.

In one embodiment, the concave room extends in a first direction that is at an angle to a second direction where the air inlet channel extends. The communicating channel is disposed in the handle and is located at one side of the air inlet channel. A drilled hole extending in a same direction of the communicating channel is provided at an opposite side of the air inlet channel. The drilled hole is sealed with a sealing block. A wear-resisting ring is disposed around the rear bucket portion to abut against the concave room. A joint between the communicating channel and the air inlet channel is located at an upstream position before the control valve.

An elastic supporting member abutting against the end wall is disposed in the air room. Preferably, the elastic supporting member is a spring.

In another embodiment, the concave room extends in a same direction of the air inlet channel. The bottom wall of the concave room is provided with a bucket member having a first annular wall extending toward the rear bucket portion while the end wall of the rear bucket portion is provided with a second annular wall extending toward the bucket member. The second annular wall is closely connected with a periphery of the first annular wall. A joint between the communicating channel and the air inlet channel is located at an upstream position before the control valve.

An elastic supporting member abutting against the end wall is disposed in the air room. Preferably, the elastic supporting member is a spring.

### BRIEF DESCRIPTION OF THE SEVERAL VIEWS OF THE DRAWINGS

FIG. 1 is a sectional view of a first embodiment of the present invention;

FIG. 2 is a sectional view showing the movement in use of the embodiment in FIG. 1;

FIG. 3 is a sectional view of a second embodiment of the present invention;

FIG. 4 is a sectional view of a conventional gun-shaped pneumatic hammer;

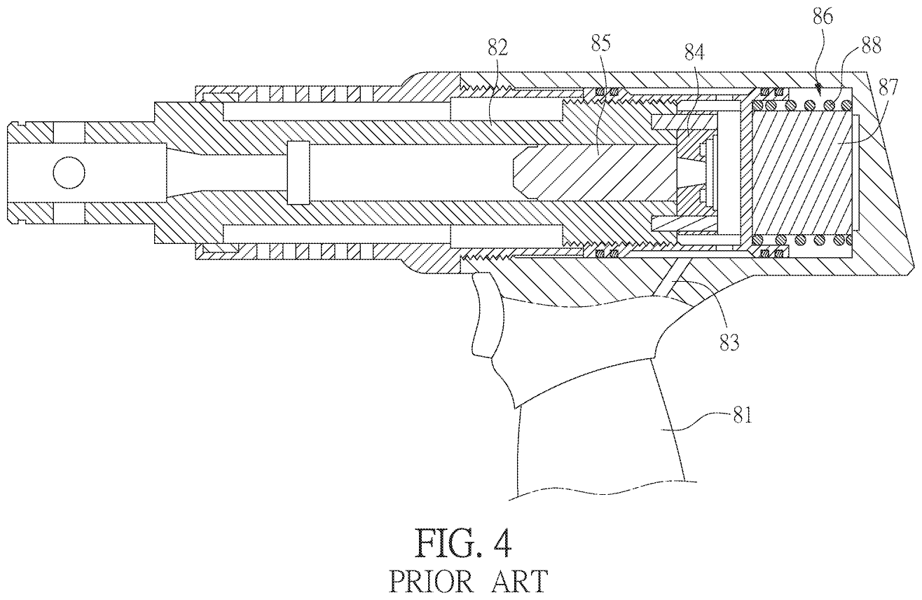

FIG. 5 is a sectional view of a conventional straight pneumatic hammer.

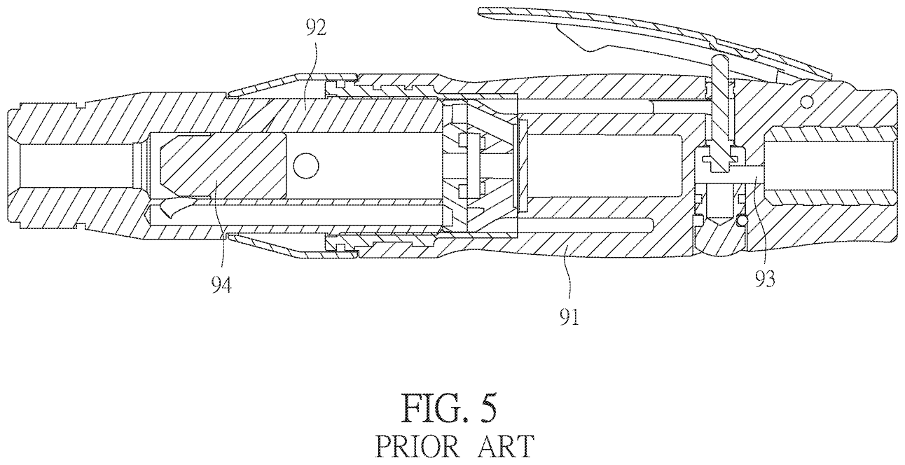

### DETAILED DESCRIPTION OF THE INVENTION

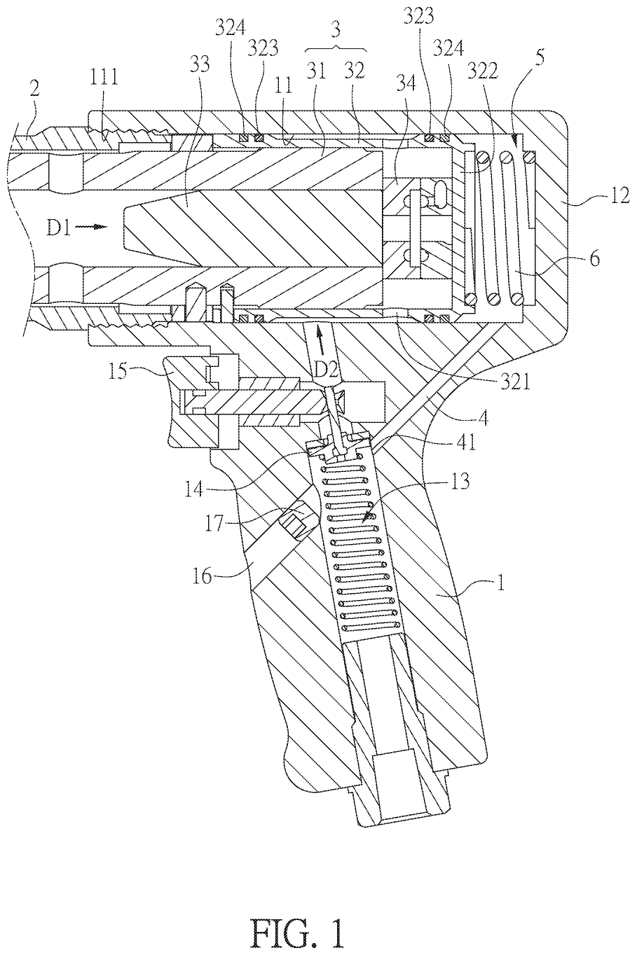

Referring to FIG. 1, the vibration reducing structure of pneumatic hammer according to a first embodiment of the present invention includes a gun-shaped handle 1, an outer tube shell 2, an inner tube shell 3 and a communicating channel 4. The top end of the handle 1 is provided with a concave room 11 extending in a first direction D1 with an opening end 111 and a bottom wall 12. The bottom end of the handle 1 is provided with an air inlet channel 13 extending in a second direction D2 to communicate with the concave room 11 for connecting with an external high pressure air supply device. The first direction D1 is at an angle to the second direction D2. A control valve 14 is disposed in the air inlet channel 13 for controlling air to pass through. The control valve 14 can be operated by a button 15 located on the handle 1.

The outer tube shell 2 is coupled with the opening end 111 of the concave room 11 through threads. The inner tube shell 3 is movably accommodated in the outer tube shell 2. The inner tube shell 3 includes a front tube portion 31 with a movable hammer member 33, a rear bucket portion 32 with an air inlet valve 34 and a hole 321 provided at a side of the rear bucket portion 32 to communicate the air inlet channel 13 and the air inlet valve 34. According to this, after entering the concave room 11 through the air inlet channel 13, high pressure air passes through the hole 321 to enter the rear bucket portion 32 and then is injected into the tube portion 31 by the air inlet valve 34 for activating the hammer member 33 to move back and forth.

An end wall 322 is disposed at the rear end of the inner tube shell 3, more particularly on the rear bucket portion 32. An air room 5 is formed between the bottom wall 12 and the end wall 322. A sealing ring 323 surrounds the rear bucket portion 32 and closely connects with the concave room 11 so as to seal gaps between the rear bucket portion 32 and the concave room 11. A wear-resisting ring 324 surrounds the rear bucket portion 32 and closely connects with the concave room 11 so as to reduce wear therebetween during vibration. A spring 6 is provided in the air room 5 to abut against the end wall 322 for supporting the rear bucket portion 32.

A communicating channel 4 is disposed in the handle 1 to connect the air inlet channel 13 and the air room 5 for high pressure air entering the air room 5 after being guided into the air inlet channel 13. In this embodiment, a joint 41 between the communicating channel 4 and the air inlet channel 13 is located at an upstream position before the control valve 14 so that high pressure air can normally enter the air room 5, not depending on a pressing operation to the button 15 to open the control valve 14. Therefore, pressure in the air room 5 is kept greater than that in the environment.

The communicating channel 4 is made by drilling on the handle 1 toward the air inlet channel 13 and the air room 5 so that a drilled hole 16 extending in a same direction of the communicating channel 4 is formed in the handle 1. The drilled hole 16 is sealed with a sealing block 17.

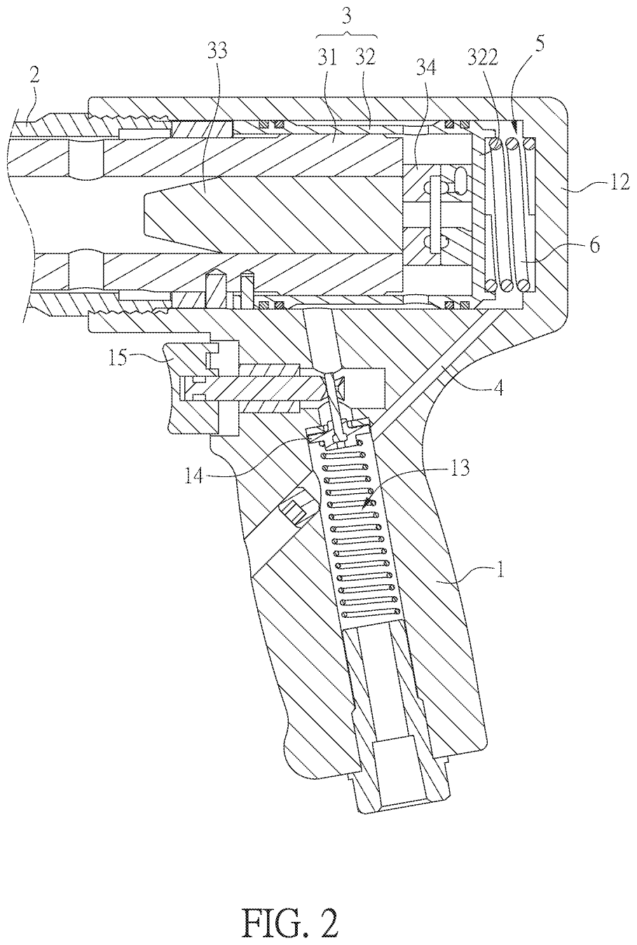

High pressure air normally injected into the air room 5 via the communicating channel 4 can be used to resist vibration generated in the course of the hammer member 33 action so that the vibration will be reduced. As shown in FIG. 2, when the hammer member 33 moves backward and causes the inner tube shell 3 to vibrate, the air in the air room 5 supports the inner tube shell 3 as a result of its high pressure. The high pressure air in the air room 5 suffers compression from the hammer member 33 several thousand times per minute, but even so it is able to restore quickly and immediately, therefore taking effect in supporting the inner tube shell 3. On the other hand, there is no shaking, as hard bodies hit each other, when air suffers compression since air is formless material. In addition, the spring 6 also supports the inner tube shell 3, which is in cooperation to reduce the vibration.

Moreover, the air room 5 is filled with high pressure air so that the air functions on the whole area of the end wall 322 uniformly to take the best effect upon vibration reducing. The present invention uses formless high pressure air instead of elastic body, like rubber chunk, etc., to reduce vibration of the inner tube shell 3, avoiding from elastic fatigue caused by high-frequency vibration to ensure its durability.

Even though higher pressure air can work the pneumatic hammer better, it causes more violent vibration. In the present invention, however, air used for being injected into the air room 5 to reduce vibration comes from the same source of that used for driving pneumatic hammer, obtaining good effect upon vibration reducing and pneumatic hammer driving in the meantime. Dilemma of upgrading working efficiency or reducing vibration is dispelled.

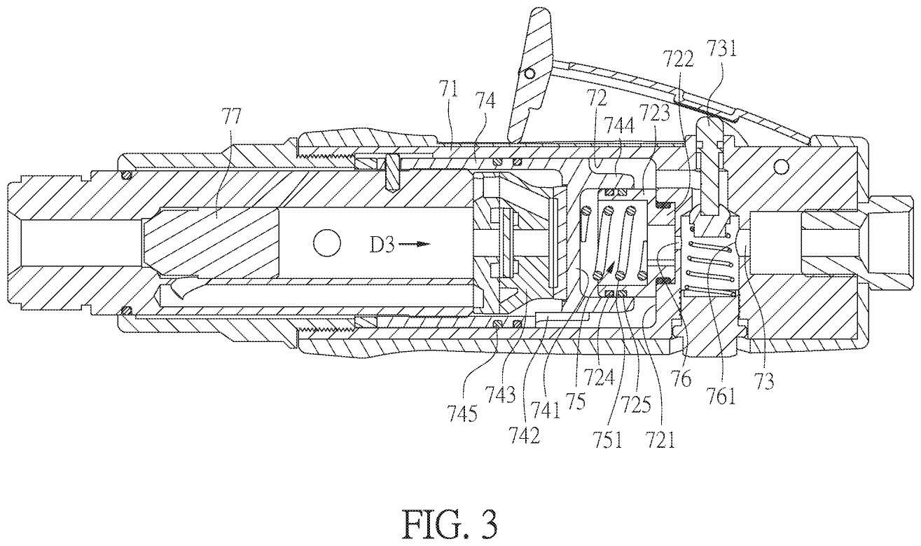

FIG. 3 shows a second embodiment of the present invention whose configuration is changed from the first embodiment abovementioned. In this embodiment, the handle 71 is straight in a direction D3 and has a concave room 72 extends in the same direction. The rear end of the handle 71 is provided with an air inlet channel 73 extending in the direction D3 to communicate with the concave room 72 for connecting with an external high pressure air supply device. A control valve 731 is disposed in the air inlet channel 73 for controlling air to pass through. A hole 742 is disposed at a side of the rear bucket portion 74 to communicate the air inlet channel 73 and the air inlet valve 743.

The bottom wall 721 of the concave room 72 is provided with a bucket member 722 having a first annular wall 723 extending toward the rear bucket portion 74. In this embodiment, the bucket member 722 is fixed with the bottom wall 721. The end wall 741 of the rear bucket portion 74 is provided with a second annular wall 744 extending toward the bucket member 722. The second annular wall 744 is closely connected with an outer surface of the first annular wall 723, and therefore an air room 75 is formed. A spring 751 is provided in the air room 75 to abut against the end wall 741 for supporting the rear bucket portion 74.

A sealing ring 724 surrounds the first annular wall 723 and closely connects with the second annular wall 744 so that gaps between the first annular wall 723 and the second annular wall 744 are sealed, and thus the air room 75 and the concave room 72 are separated.

A front wear-resisting ring 745 surrounds the rear bucket portion 74 and abuts against the concave room 72 while a rear wear-resisting ring 725 surrounds the first annular wall 723 and abuts against the second annular wall 744 so that the rear bucket portion 74 is well supported when moving back and forth. Hence, the rear bucket portion 74 can move smoothly in the concave room 72.

A communicating channel 76 is provided to connect the air inlet channel 73 and the air room 75 for high pressure air entering the air room 75 after being guided into the air inlet channel 73. A joint 761 between the communicating channel 76 and the air inlet channel 73 is located at an upstream position before the control valve 731 so that high pressure air can normally enter the air room 75. Therefore, pressure in the air room 75 is kept greater than that in the environment so as to reduce the vibration caused by movement of the hammer member 77.

What is claimed is:

1. A vibration reducing structure of pneumatic hammer comprising:
a handle having a concave room with an opening end and a bottom wall, the handle having an air inlet channel communicating with the concave room, the air inlet channel being provided with a control valve for controlling air to pass through;
an outer tube shell coupled with the opening end of the concave room;
a movable inner tube shell accommodated in the outer tube shell with a front tube portion and a rear bucket portion extending into the concave room, wherein the front tube portion is provided with a movable hammer member, the rear bucket portion is provided with an air inlet valve for activating the hammer member and a hole communicating the air inlet channel to the air inlet valve;
an air room formed between the bottom wall and an end wall of the rear bucket portion, wherein a sealing ring is provided on the rear bucket portion to closely connect with the concave room; and
a communicating channel communicating the air inlet channel to the air room for air with high pressure entering the air room.

2. The vibration reducing structure of pneumatic hammer of claim 1, wherein the concave room extends in a first direction that is at an angle to a second direction where the air inlet channel extends.

3. The vibration reducing structure of pneumatic hammer of claim 2, wherein the communicating channel is disposed in the handle and is located at one side of the air inlet channel, a drilled hole extending in a same direction of the communicating channel is provided at an opposite side of the air inlet channel, the drilled hole is sealed with a sealing block.

4. The vibration reducing structure of pneumatic hammer of claim 2, wherein a wear-resisting ring is disposed around the rear bucket portion to abut against the concave room.

5. The vibration reducing structure of pneumatic hammer of claim 2, wherein a joint between the communicating channel and the air inlet channel is located at an upstream position before the control valve.

6. The vibration reducing structure of pneumatic hammer of claim 2, wherein an elastic supporting member abutting against the end wall is disposed in the air room.

7. The vibration reducing structure of pneumatic hammer of claim 6, wherein the elastic supporting member is a spring.

8. The vibration reducing structure of pneumatic hammer of claim 1, wherein the concave room extends in a same direction of the air inlet channel; the bottom wall of the concave room is provided with a bucket member having a first annular wall extending toward the rear bucket portion while the end wall of the rear bucket portion is provided with a second annular wall extending toward the bucket member, the second annular wall being closely connected with a periphery of the first annular wall.

9. The vibration reducing structure of pneumatic hammer of claim 8, wherein a front wear-resisting ring is disposed around the rear bucket portion to abut against the concave room, and a rear wear-resisting ring is disposed around the first annular wall to abut against the second annular wall.

10. The vibration reducing structure of pneumatic hammer of claim 8, wherein a joint between the communicating channel and the air inlet channel is located at an upstream position before the control valve.

11. The vibration reducing structure of pneumatic hammer of claim 8, wherein an elastic supporting member abutting against the end wall is disposed in the air room.

12. The vibration reducing structure of pneumatic hammer of claim 11, wherein the elastic supporting member is a spring.
